(19) United States
(12) Patent Application Publication
(10) Pub. No.: US 2011/0226926 A1
(43) Pub. Date: Sep. 22, 2011

(54) Holder for holding clampingly a flat object

(76) Inventor: Augustinus Martinus Maria Ammann, Rosmalen (NL)

(21) Appl. No.: 12/727,681

(22) Filed: Mar. 19, 2010

(51) Int. Cl. A47G 1/24; A47G 1/16; G09F 3/00

(52) U.S. Cl. 248/479; 248/475.1; 40/299.01

(57) ABSTRACT

The invention relates to a holder for holding clampingly a flat object such as a photo, greetings card or drawing, wherein the holder is adapted to be fixed clampingly to a structure, wherein the holder has a decorative appearance. The decoration serves here to obtain a more attractive appearance. Although practical, a hospital bed or hospital room is also cheerless. When a patient is sent a get-well card or photo, it is now usually arranged on a noticeboard behind the patient. The card is hereby situated outside the field of vision of the patient. According to a preferred embodiment, the holder is adapted to be fixed clampingly to a structure at the foot of a bed, in particular a hospital bed.

### FIELD OF INVENTION

The invention relates to a holder for holding clampingly a flat object such as a photo, greetings card, character or drawing, wherein the holder is adapted to be fixed clampingly to a structure.

### BACKGROUND OF THE INVENTION

Such holders are known in the form of clamps, which are used in shops to attach size or price cards to bars of a sales structure, such as a clothes rack. Although such holders have an attractive appearance, they have little decorative value.

### SUMMARY OF THE INVENTION

The invention has for its object to provide such a clamp with a more attractive appearance, so that such holders can be applied in other situations, such as in a domestic setting or in hospitals.

The present invention provides for this purpose a holder for holding clampingly a flat object such as a photo, greetings card, character or drawing, wherein the holder is adapted to be fixed clampingly to a structure, wherein the holder has a decorative appearance. The decoration serves here to obtain a more attractive appearance.

Practical and hygienic considerations in hospitals do not enhance the atmosphere. Fluorescent lighting and the practical products and materials applied in the rooms of a hospital are completely at odds with an attractive environment. Although practical, a hospital bed or hospital room is also cheerless. When a patient is sent a get-well card or photo, it is now usually arranged on a noticeboard behind the patient. The card is hereby situated outside the field of vision of the patient.

According to a preferred embodiment, there is provided such a holder which is adapted to be fixed clampingly to a hospital bed. An attractive, practical and original get-well gift is thus provided in the form of the holder according to the invention, which in a simple operation can be clamped onto the horizontal bar of a hospital bed, at the foot of the bed, so that this bar at the foot of a hospital bed is used for presentation purposes within the field of vision of the patient so as to make the stay of a patient in a hospital more pleasant. It is noted here that the application of the invention is not limited to use on the bar at the foot of a hospital bed. It is of course also possible to place the holder on other structures, such as on a lift bar or so-called trapeze bar of a hospital bed or on a pivot arm on which television sets are usually mounted.

According to a first preferred embodiment, the holder is provided with at least one substantially semicircular, to some extent resilient clamp which forms a whole with the holder and which is adapted to engage on a substantially horizontally extending bar. An effective clamp is hereby obtained using a simple configuration.

Although in many hospitals beds are present with a round bar of a standard size at the foot thereof, the need to clamp a holder on such a bar with different dimensions or with a non-round section cannot be precluded. It also occurs that hospital beds are not provided with such a bar and that the holder must be clamped to another part of the bed, for instance a panel. For such situations a preferred embodiment provides the measure that the clamp is provided at least partially on its inner side with a layer of resilient material. Differences in shape and size can hereby be compensated. Because of the presence of the resilient layer the actual clamp must therefore have a slightly larger inner dimension than the thickest structure to which it must be possible to fix the holder. This measure also provides more options than the foregoing measure for clamping the holder fixedly to a structure not forming part of a hospital environment.

The railing or bar at the foot of a hospital bed is an ideal place for presenting a photo or get-well card in the field of vision of a patient, to ‘boost’ a patient and to ‘pimp’ a hospital bed. It is further a significant advantage that the parts can be assembled as a construction kit. This has the advantage that the parts with the protruding tube clamping parts can be packed in nestable manner, whereby shop space can be utilized as efficiently as possible. An additional advantage here is that, when the kit parts are sent, the postal package does not become too thick to fit through the letterbox.

It is further not excluded that the holder is adapted to be clamped on a bar of for instance a back of a chair, for instance at meeting locations.

The possibilities for fixing of the holder are improved still further when the holder is provided with at least one clamp which comprises at least one part which is connected tiltably to the holder and when the holder and the part connected tiltably to the holder are connected to a resilient element which is adapted to urge to the clamping position the part connected tiltably to the holder. Such a clamp provided with a movable part can after all engage effectively on structures with greater variation in thickness.

Owing to an improved attachment and the possibility of obtaining a symmetrical appearance, it is attractive when the holder is provided with two clamps situated mutually in line.

Although there are numerous possibilities for fixing the flat object such as a card in the holder, it is recommended that the holder is provided with at least one groove for clampingly engaging the flat object.

Often it is easier to locate the holder with the card on a flat surface, as in situations wherein a bar is not available. In such a situation the holder is located on a table or on a bedside table. This also offers the possibility to use the holder for other purposes, like in restaurants where the holder may hold the menu, a reservation notice or a name card at a dinner. The holder can also be used in commercial environments for holding greeting cards, notices with items not to be forgotten. In such situations the clamping force of the holder as described before is insufficient. This is in particular the case when the structure on which the holder is to be clamped, like the rod of a hospital bed, has dimensions which are too large for which the holder is dimensioned. To provide a good clamping in such situations, a preferred embodiment provides the feature that a tape made of elastically material extends around the holder. This elastic tape provides the clamping force, or at least a substantial part thereof so that the same holder can be attached with sufficient clamping force on structures with several dimensions. It will be clear that the invention also relates to a combination of the two halves of a holder an elastic tape.

Although it is not excluded that the tape may be formed by a rubber tape ring as it is used by postal organisations to keep together stacks of mail, with its longitudinal direction crossing the tilt axis of the clamp, it is preferred that the tape extends parallel to the tilt axis of the clamp. The tilt axis herein is to be understood as the axis around which the parts of the clamp or clamps may tilt.

Generally the tape is well visible, which often may affect the appearance of the holder. To avoid this, it is attractive if the tape has been made from transparent material.

It is however also possible that the tape is provided with a decoration. This avoids disturbance of the appearance. Further this feature offers the possibility to adapt the decoration to the decoration on the holder itself. This decoration, possibly as a text, may form a decorative unit with the holder or the card, or supplement the card or the holder. The name of a person can be applied on the tape while the menu is printed on the card fitted into the holder. In a congress centre the holder can be clamped on the back of a chair with the name of the organiser on the tape, while the program is printed on the card.

To keep the tape located it is preferred that the holder comprises a groove extending in a main surface of the holder adapted to at least partially lodge the tape.

Matching between the decoration and the holder can be obtained if the holder comprises a staggered surface of which the edges extend substantially parallel to the groove. This provides a striped structure, also in dependence from the light, leading to integration of the tape.

It is also possible that the holder comprises notches at its edges for at least partially lodge the tape. This also forms a good location for the tape. This feature can be combined with the preceding feature.

Yet another preferred embodiment provides the feature that both halves have a different colour or have a transparent effect. This offers the user the possibility to maintain the most attractive colour to his side.

Further this feature offers the possibility that at least one of the halves comprises an aperture through which the other half is visible to obtain a contrast effect with an appropriate choice of colour.

There are other possibilities for obtaining a contrast like when an aperture has been made in at least one of the halves and that on at least one side of the holder a decorative element has been positioned which is clamped in the aperture. Preferably though not necessarily the decorative element has a contrasting colour. An example of such an element is a red clowns nose. Although above has been indicated that the decorative element has been attached by clamping, other methods of fixing like gluing or welding are not excluded.

Often there is a need for mutual coupling of holders according to the invention, or for fixing another item to a holder than a card. Hence a preferred embodiment provides a holder which is at its upper side is provided of at least one coupling element adapted to couple the holder to an object located above the holder. Therewith holders according to the invention can be mutually coupled to allow towers of holders to be built.

Therefore use can be made of a several types of coupling but it is simple if the coupling element located at the upper side is adapted to couple with an identical holder located above the holder and that the holder comprises at its lower side a coupling element adapted to couple with an identical holder located underneath the holder.

Preferably the coupling is a clamp coupling adapted to couple with the coupling element of a second holder.

It is however also possible when the coupling elements comprise each a notch provided in one of the halves of the holder.

An exceptionally preferred embodiment provides the feature that the coupling elements comprise in both adjacent halves a notch in the middle of the edge of the holder at both sides of the middle of the edges of which the width is equal to the thickness of the half of the holder.

In order to simplify production and logistics the holder is preferably assembled from two identical plastic halves.

In order to increase the appeal of the holder and to improve the mood of the patient when the holder is placed on a hospital bed, it is recommended that the decorative appearance is formed by at least a part of the holder which is embodied as a character with the appearance of a cartoon, an animal, a person or a plant.

This favourable effect is further enhanced when the holder comprises a central part which has the appearance of the head of an animal, such as a cat or a rabbit, and the clamps are embodied as hind legs of the animal and the clamps for clamping the card are embodied as forelegs of the animal. In the case of a rabbit there is the further option of using the ears instead of the forelegs.

The clarity of the decorative appearance is further improved when the decorative appearance is obtained with a graphic image arranged on at least a part of the holder.

The cheering effect of the assembly of card and holder can be further improved when the holder is provided with a space for a battery and, connectable to the battery, at least one light source, loudspeaker or drive means for driving a part connected movably to the holder.

Yet another preferred embodiment provides the measure that the decorative appearance of the holder fits together with the image arranged on the greetings card. This creates the possibility of having the character on the holder form part of the image of the card, which provides a large number of decorative options. It will be apparent that cards with different images fall within this embodiment. It is therefore attractive for holders according to the invention to be available in a hospital shop, as well as a series of different cards, which are preferably each provided with an image fitting together with the character represented by the holder.

It is however also possible for the holder to be provided with cards with advertising, such as for services relating to discharge from the hospital. It is then possible by way of advertising to offer patients a holder according to the invention together with such an advertising card. When greetings cards are received, they can take the place of the advertising card.

### BRIEF DESCRIPTION OF THE DRAWINGS

The present invention will be further elucidated on the basis of the non-limitative exemplary embodiments shown in the following accompanying figures. Herein:

FIG. 1 shows a front view of a first embodiment of a holder according to the invention clamped on the railing or bar of a hospital bed in combination with a greetings card;

FIG. 2 is a cross-sectional view of the first embodiment shown in FIG. 1;

FIG. 3 is a front view of one of the parts of the first embodiment shown in FIGS. 1 and 2;

FIG. 4 is a cross-sectional view of the first embodiment shown in FIG. 3 in disconnected situation;

FIG. 5 is a cross-sectional view of the first embodiment shown in FIG. 3 in connected situation;

FIG. 6 shows a front view of a second embodiment;

FIG. 7 shows a front view of a third embodiment;

FIG. 8 shows a front view of a fourth embodiment;

FIG. 9 is a cross-sectional view of the embodiment shown in FIG. 8;

FIG. 10 shows a cross-sectional view of a fifth embodiment;

FIG. 11 shows a front view of a sixth embodiment;

FIG. 12 shows a side view of the sixth embodiment;

FIG. 13 shows a figure corresponding to FIG. 11 wherein a tape has been provided;

FIG. 14 shows a figure corresponding to FIG. 12 wherein a tape has been provided;

FIG. 15 shows a side view of a combination of two holders; and

FIG. 16 shows a detailed perspective view of the combination depicted in FIG. 15.

### DETAILED DESCRIPTION

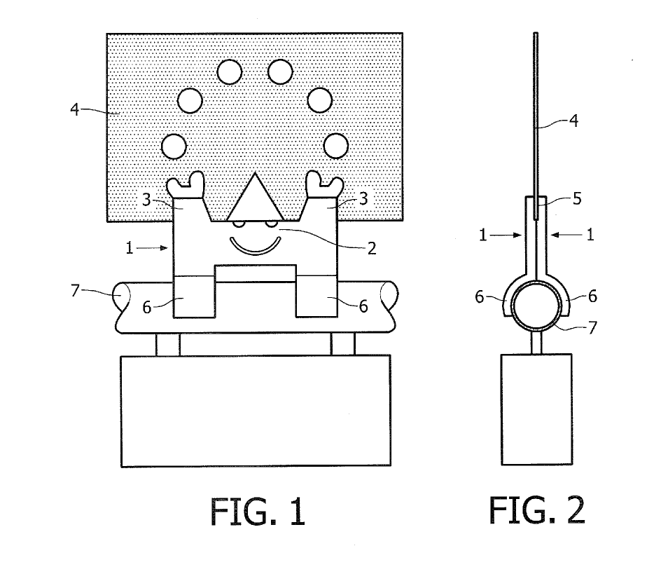

FIG. 1 shows a front view of a holder 1 which is provided with a decorative element in the form of a face 2. Holder 1 is provided with clamping elements 3 which are adapted for clamping engagement of a greetings card 4. The holder is also provided with engaging elements 6 for engaging on a horizontally extending bar 7 at the foot of a hospital bed.

In the present embodiment clamping elements 3 for card 4 take the form of the arms of the character of which face 2 forms part. Engaging elements 6 further take the form of legs of this character. Card 4 is provided with a decoration, in the present case two hands which, when the card is positioned correctly, connect to clamping elements 3 in the form of arms. The decoration further comprises a series of balls which are being thrown into the air by the character.

Said components are likewise shown in FIG. 2, which shows a cross-sectional view of holder 1. Here can be seen that the holder consists of two identical parts which comprise a groove 5 on their upper side, into which card 4 is inserted and which is adapted to secure card 4.

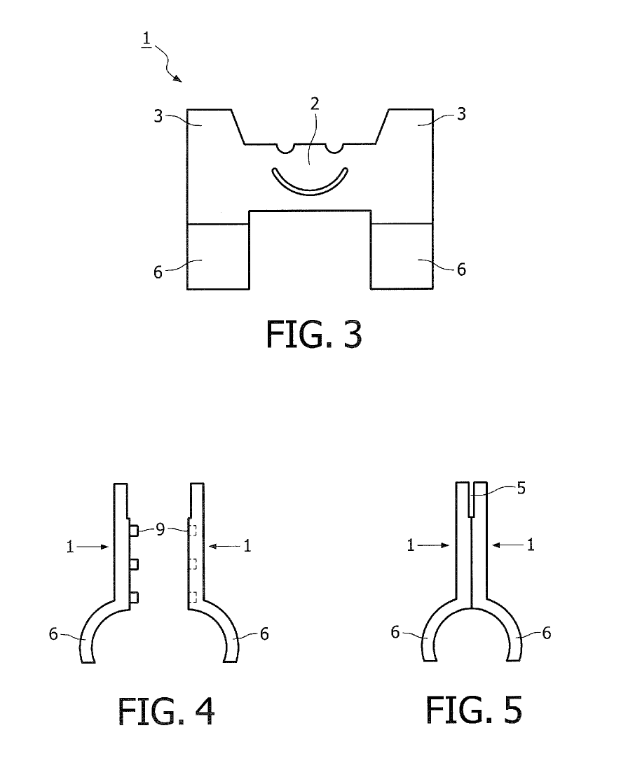

FIG. 3 shows a front view of one of the two parts 1, which both take the form of a character with a face 2, with arms 3 and legs 6.

FIG. 4 is a cross-sectional view of the two parts 1 as shown in FIG. 3, which shows that the two parts 1 can be connected to each other by a form-fitting pin and hole connection 9. It is otherwise also possible to make use of an adhesive connection. It is important here that the holder be manufactured from material which is to some extent flexible, so as to make it possible for the engaging elements to bend apart to some extent in order to enable the arrangement round the bar.

FIG. 5 shows a cross-sectional view corresponding to FIG. 4, wherein the two parts 1 are mutually connected.

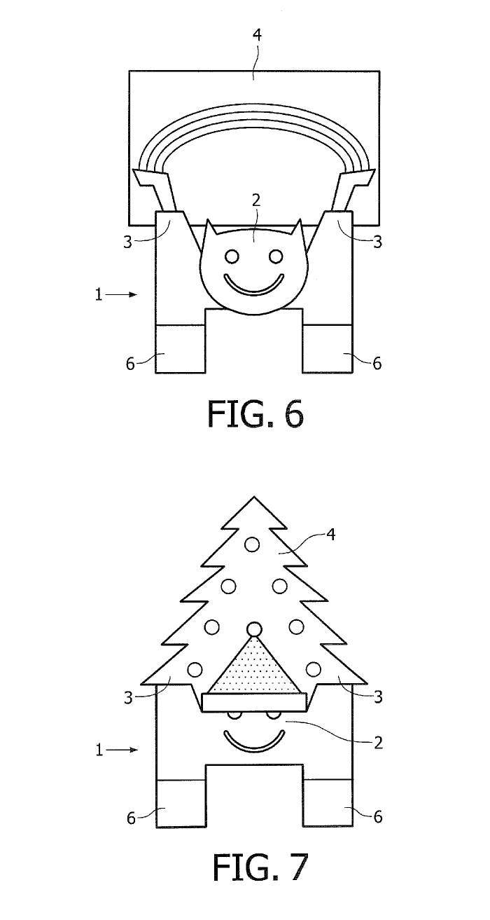

FIG. 6 shows a front view of a holder 1 provided with a greetings card 4. A decoration differing from that of FIGS. 1-5 is applied here in the form of the face 2 of a cat, with cat forelegs 3 and cat hind legs 6. Card 4 is provided here with a decoration in the form of the ‘paws’ of a cat and a rainbow, whereby the images on the card and the holder fit together.

FIG. 7 shows another view corresponding to FIG. 6, wherein the holder is provided with the decoration in the form of a Santa Claus, and the card is provided with a decoration related thereto in the form of a Christmas tree.

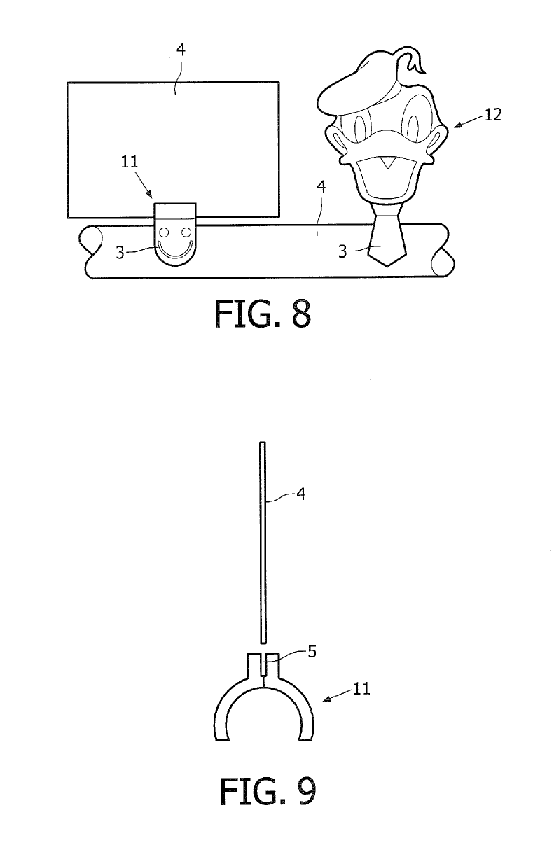

FIG. 8 shows a front view of an embodiment wherein the holder is provided with a single clamp 11, which is itself not provided with a decoration but which is supplied together with a separate decoration 12 in the form of a ‘Donald Duck’ character 12 which, like holder 11, is attached by means of a clamp to bar 7 of a hospital bed. Card 4 can here be provided with a cartoon character related to Donald Duck, such as the three nephews Huey, Dewey and Louie.

FIG. 9 is a cross-sectional view of the embodiment shown in FIG. 8. The construction of the parts corresponds with that of holders 1 of the above elucidated embodiments.

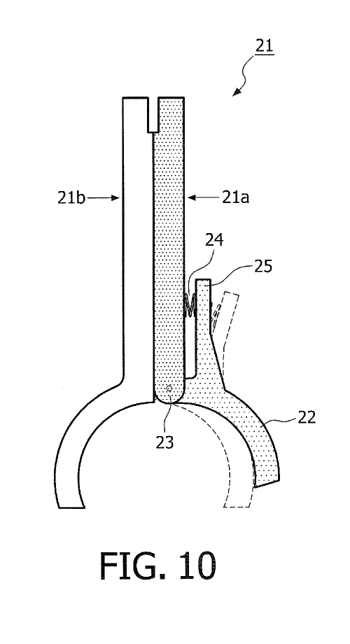

Finally, FIG. 10 shows a cross-sectional view of another embodiment of the holder, wherein one of the halves of the holder is provided with a jaw 22 connected pivotally to holder 21. For this purpose one of the holder halves 21 a is provided with a hinge 23 so that jaw 22 can tilt relative to holder half 22. Arranged between holder half 21a and jaw 22 is a spring 24 which urges jaw 22 to the closed position. For the purpose of opening jaw 22 by hand a lever 25 is connected rigidly to jaw 22. The other holder half 21b is provided in this embodiment, as in the foregoing embodiments, with a jaw connected fixedly to the holder half. It will be apparent that it is also possible to provide both holder halves with such a pivotally connected jaw. Owing to this pivoting jaw the holder can be clamped onto larger objects, such as tubes of a greater diameter, tubes with a non-round form or even on objects with a straight edge, such as panels. This is particularly applicable to beds which are not provided with a bar and where the holder must be attached to a panel situated at the foot of the bed. This measure also provides the option of attaching the holder to objects other than a bed.

Finally, it is pointed out that a layer of resilient material can be placed on the inner side of the jaws. When the diameter of the jaws is sufficiently large, this results in a further possibility of fixing the holder onto objects of differing shape. Such a layer can otherwise also be arranged on the inner side of engaging elements 6 of the foregoing embodiment with fixed engaging elements, thereby also increasing the fixing options. It is also possible to apply an element which is connected tiltably to a movable jaw and placed on the inner side of the jaw for the purpose of a better contact of the jaw.

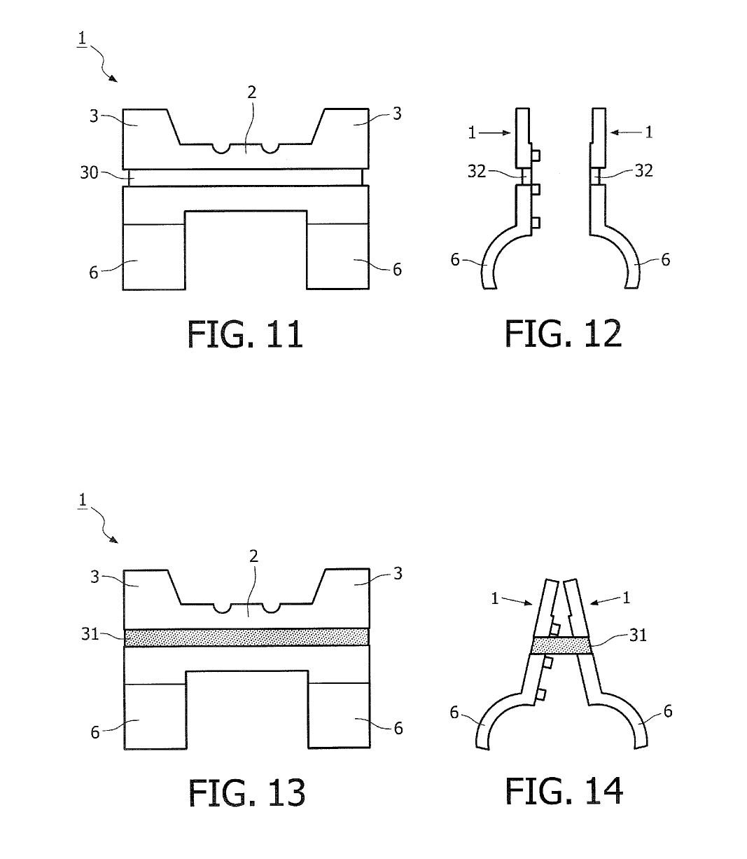

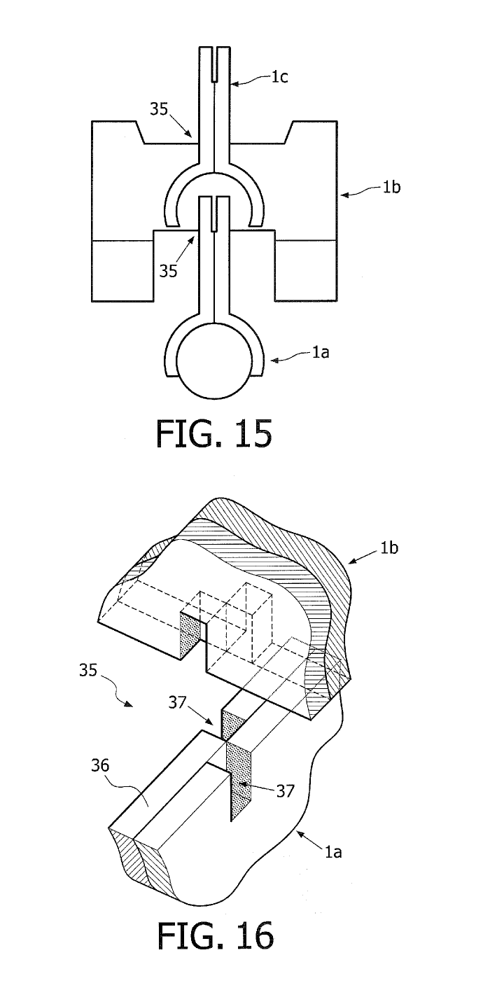

The sixth embodiment depicted in FIG. 11 is substantially in accordance with the embodiment depicted in FIG. 3, although in the front surface of the holder 2 a groove 30 has been provided, just as in the rear surface thereof. The groove is a shallow groove with a relatively great width dimensioned to absorb a tape to be located surrounding the holder. This tape 31 serves for generating a force urging the two halves together when the halves composing the holder are moved away from each other, wherein the force functions as a clamping force for clamping the halves to a structure. This tape can be made of rubber or from another elastic substance as an artificial rubber or a plastic.

Preferably the tape has a width of about 6 mm and a thickness of about 1 mm. It will be clear that the sizes of the tape can be adapted to the sizes of the holder. Preferably the groove in the holder is a bit wider than the tape and is sufficiently deep to keep the tape in its location.

FIG. 13 shows a holder wherein a tape 31 is located in the groove.

Besides the groove 30 the edges of the holder may be provided of a notch to determine the location of the elastic tape 31. These notches 32 may be used on their own but they can also be used in combination with the groove 31. The dimensions of these features must be adapted to keep the tape at its location, not only with the joined parts of the holder, but also when the parts are moved away from each other to allow the holder to be located on a structure. As the parts of the holder may take a mutually slanted position, the tape does not only generate a force perpendicular to the faces of the parts of he holder, but also a force with a component parallel to the face of the holder, which could lead to shift of the tape. The features mentioned above should absorb these forces without shifting the tape.

FIG. 14 shows a combination of three holders 1a, 1b, 1c respectively, which are mutually joined. This possibility for joining offers novel decorative possibilities for the holder 1 according to the invention. To join two holders 1, each holder comprises a coupling at their lower or upper sides a coupling 35. Although several types of coupling could be used, an attractive coupling is depicted in FIG. 16.

The coupling 35 depicted in FIG. 16 comprises two notches 37 provided in the upper edge of the holder 1a. The notches 37 each extend to a certain depth into the plate shaped parts of the holder 1. Further the notches extend from the side edges to the half of the thickness of the plate shaped parts. Further they have been located mutually adjacent on the edges. Hence the coupling is equal to its complementary shape so that two identical couplings can be joined together. In the present embodiment the plate shaped part of the holder is composed of two identical shapes. The advantage thereof is that the identical halves can be used and that a single mould is required for producing the halves. Further the coupling is located in the centre so that the holders 1a, 1b and 1c coupled together are balanced. Also at the lower edges of the holders such a coupling has been provided, being adapted to engage the identical upper coupling of the lower holder. Also here these advantages develop.

It will be clear that the coupling may be used for stacked connection of a number of holders. Also the coupling may be used for locating on a holder according to the invention a different elements than a holders according to the invention. When another holder or another object is located on the holder no card can be clamped into the holder. Of course a card can be clamped into the upper holder of a stack. Hence the coupling can also be used for other fields than in card holders

1. Holder for holding clampingly a flat object such as a photo, greetings card or drawing, wherein the holder is adapted to be fixed clampingly to a structure, characterized in that the holder has a decorative appearance.

2. Holder as claimed in claim 1, characterized in that the holder is adapted to be fixed clampingly to a structure at the foot of a bed.

3. Holder as claimed in claim 2, characterized in that the holder is provided with at least one substantially semicircular, resilient clamp which forms a whole with the holder and which is adapted to engage on a substantially horizontally extending bar.

4. Holder as claimed in claim 3, characterized in that the clamp is provided at least partially on an inner side with a layer of resilient material.

5. Holder as claimed in claim 2, characterized in that the holder is provided with at least one clamp which comprises at least one part which is connected tiltably to the holder, and that the holder and the part connected tiltably to the holder are connected to a resilient element which is adapted to urge to the clamping position the part connected tiltably to the holder.

6. Holder as claimed in claim 3, characterized in that the holder is provided with two clamps situated mutually in line.

7. Holder as claimed in claim 6, characterized in that the holder is adapted to fix a card on a horizontal bar of a structure at the foot of a hospital bed.

8. Holder as claimed in claim 1, characterized in that the holder is provided with at least one groove for clampingly engaging the flat object.

9. Holder as claimed in claim 3, characterized in that the holder is assembled from two identical plastic halves.

10. Holder as claimed in claim 9, characterized in that the at least one clamp is adapted to be located on a flat surface.

11. Holder as claimed in claim 3, characterized in that a tape made of elastic material extends around the holder.

12. Holder as claimed in claim 11, characterized in that the tape extends parallel to a tilt axis of a clamp.

13. Holder as claimed in claim 11, characterized in that the tape has been made from transparent material.

14. Holder as claimed in claim 11, characterized in that the tape is provided with a decoration.

15. Holder as claimed in claim 11, characterized in that the holder comprises a groove extending in a main surface of the holder adapted to at least partially lodge the tape.

16. Holder as claimed in claim 15, characterized in that the holder comprises a staggered surface of which the edges extend substantially parallel to the groove.

17. Holder as claimed in claim 11, characterized in that the holder comprises notches at its edges for at least partially lodging the tape.

18. Holder as claimed in claim 10, characterized in that both halves are different colors.

19. Holder as claimed in claim 18, characterized in that at least one of the halves comprises an aperture through which the other half is visible.

20. Holder as claimed in claim 10, characterized in that an aperture has been made in at least one of the halves and that at at least one side of the holder a decorative element has been positioned which is clamped in the aperture.

21. Holder as claimed in claim 10, characterized in that the holder comprises an upper side and lower side, and the holder is at the upper side provided with at least one coupling element adapted to couple the holder to a body located above the holder.

22. Holder as claimed in claim 21, characterized in that the coupling element located at the upper side is adapted to couple with the an identical holder located above the holder and that the holder comprises at the lower side a coupling element adapted to couple with an identical holder located underneath the holder.

23. Holder as claimed in claim 22, characterized in that the clamping coupling with the coupling element of a second holder.

24. Holder as claimed in claim 23, characterized in that the coupling elements comprise each a notch provided in one of the halves of the holder.

25. Holder as claimed in claim 24, characterized in that the coupling elements comprise in both adjacent halves a notch in the middle of the edge of the holder at both sides of the middle of the edges of which the width is equal to the thickness of the half of the holder.

26. Holder as claimed in claim 1, characterized in that the decorative appearance is formed by at least a part of the holder which is embodied as a character with the appearance of a cartoon, an animal, a person or a plant.

27. Holder as claimed in claim 10, characterized in that the holder comprises a central part which has the appearance of the head of an animal, and that the clamps are embodied as hind legs of the animal and the clamps for clamping the card are embodied as forelegs of the animal.

28. Holder as claimed in claim 1, characterized in that the decorative appearance is obtained with a graphic image arranged on at least a part of the holder.

29. Holder as claimed in claim 1, characterized in that the holder is provided with a space for a battery and, connectable to the battery, at least one light source, loudspeaker or drive means for driving a part connected movably to the holder.

30. Combination of a holder as claimed in claim 1 and a greetings card, characterized in that the decorative appearance of the holder fits together with the image arranged on the greetings card.
